(19) United States
(12) Patent Application Publication
(10) Pub. No.: US 2024/0312774 A1
(43) Pub. Date: Sep. 19, 2024

(54) METHOD AND SYSTEM FOR TIMED INTRODUCTION OF SAMPLE INTO A MASS SPECTROMETER

(71) Applicant: DH TECHNOLOGIES DEVELOPMENT PTE. LTD., Singapore (SG)

(72) Inventors: Peter Kovarik, Markham (CA); Thomas Covey, Newmarket (CA); Gordana Ivosev, Etobicoke (CA); Chang Liu, Richmond Hill (CA)

(21) Appl. No.: 18/268,438

(22) PCT Filed: Sep. 24, 2021
(86) PCT No.: PCT/IB2021/000654

§ 371 Date: Jun. 20, 2023

Related U.S. Application Data
(60) Provisional application No. 63/130,114, filed on Dec. 23, 2020.

(51) Int. Cl. H01J 49/04; H01J 49/00

(52) U.S. Cl. CPC H01J 49/0418; H01J 49/0036

(57) ABSTRACT

Systems and methods are disclosed for timed introduction of samples into a mass spectrometer may include receiving a plurality of sample ion pulses in a mass spectrometer from a sampling interface, where the sample ion pulses are received at a pre-determined time pattern; detecting the received sample ion pulses to generate a signal; isolating an analyte signal by signal conditioning the generated signal based on the pre-determined time pattern; and identifying a presence of an analyte based on the isolated analyte signal. The signal conditioning may include pulse-based averaging based on the pre-determined time pattern or may include converting the generated signal to a frequency-domain signal and calculating a modulus to isolate the analyte signal. The pre-determined time pattern may be periodic where the signal conditioning comprises performing a Fourier Transform on the signal to convert it to a frequency-domain signal.

### CROSS-REFERENCE TO RELATED APPLICATIONS/INCORPORATION BY REFERENCE

This application claims priority to U.S. Provisional Patent Application No. 63/130,114, filed on Dec. 23, 2020, entitled “Method And System For Timed Introduction of Sample Into a Mass Spectrometer”.

### BACKGROUND

Conventional approaches for mass spectrometry may be costly, cumbersome, and/or inefficient—e.g., they may be complex and/or difficult to implement.

### BRIEF DESCRIPTION OF SEVERAL VIEWS OF THE DRAWINGS

FIG. 1A shows a high level block diagram of a sample processing system according to an embodiment of the disclosure.

FIG. 1B is a block diagram that illustrates a computer system, upon which embodiments of the present teachings may be implemented.

FIG. 1C is a schematic diagram of a sample introduction apparatus, in accordance with an example embodiment of the disclosure.

FIG. 1D schematically depicts an embodiment of a droplet injection and ionization system, in accordance with an example embodiment of the disclosure.

FIG. 2 is a schematic diagram of a mass spectrometer system, in accordance with an example embodiment of the disclosure.

FIG. 3 illustrates example sample pulses in a mass spectrometer, in accordance with an example embodiment of the disclosure.

FIG. 4 illustrates a time-dependent ion count measurement for three concentrations, in accordance with an example embodiment of the disclosure.

FIG. 5 illustrates mass analysis results at various concentrations following Fourier transform analysis, in accordance with an example embodiment of the disclosure.

FIG. 6. illustrates a carrier frequency magnitude versus concentration plot in an eight point calibration, in accordance with an example embodiment of the disclosure.

FIG. 7 illustrates ion count data versus time for different concentration samples, in accordance with an example embodiment of the disclosure.

FIG. 8 illustrates carrier frequency count magnitude for discrete Fourier transform processed calibration signals, in accordance with an example embodiment of the disclosure.

FIGS. 9A and 9B illustrate time domain multiple reaction monitoring signal generated by a mass spectrometer for an analyte of interest, in accordance with an example embodiment of the disclosure.

FIG. 10 is a flow diagram illustrating mass spectrometry with a pre-determined pattern sample introduction and signal processing, in accordance with an example embodiment of the disclosure.

### SUMMARY

A system and/or method for timed introduction of sample into a mass spectrometer, substantially as shown in and/or described in connection with at least one of the figures, as set forth completely in the claims.

These and other advantages, aspects and novel features of the present disclosure, as well as details of an illustrated embodiment thereof, will be more fully understood from the following description and drawings.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or”. As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or z” means “one or more of x, y, and z.” As utilized herein, the terms “e.g.,” and “for example” set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a semiconductor device may be turned sideways so that its “top” surface is facing horizontally and its “side” surface is facing vertically, without departing from the teachings of the present disclosure.

The current state of product development, and scientific advancement in general, for example in the life sciences, is hampered by current systems and methods, adding literally years to product and/or scientific development cycles.

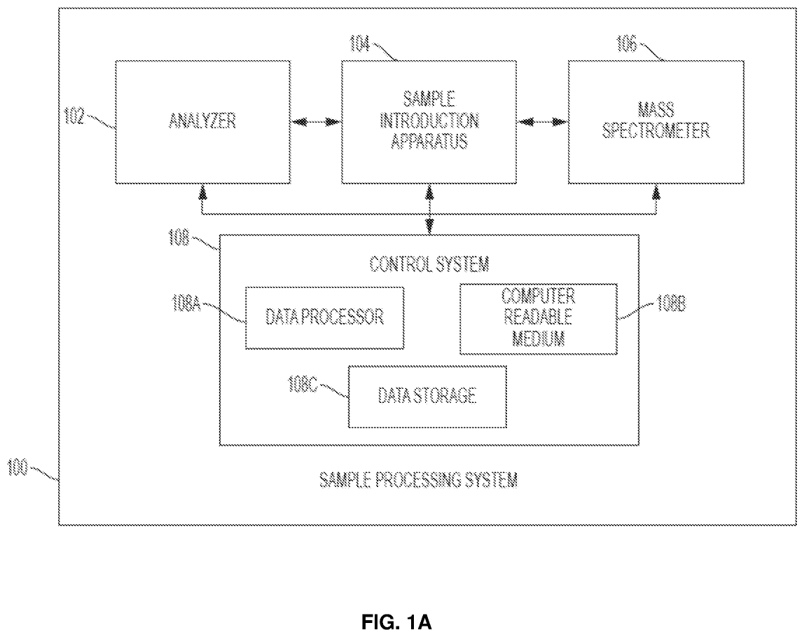

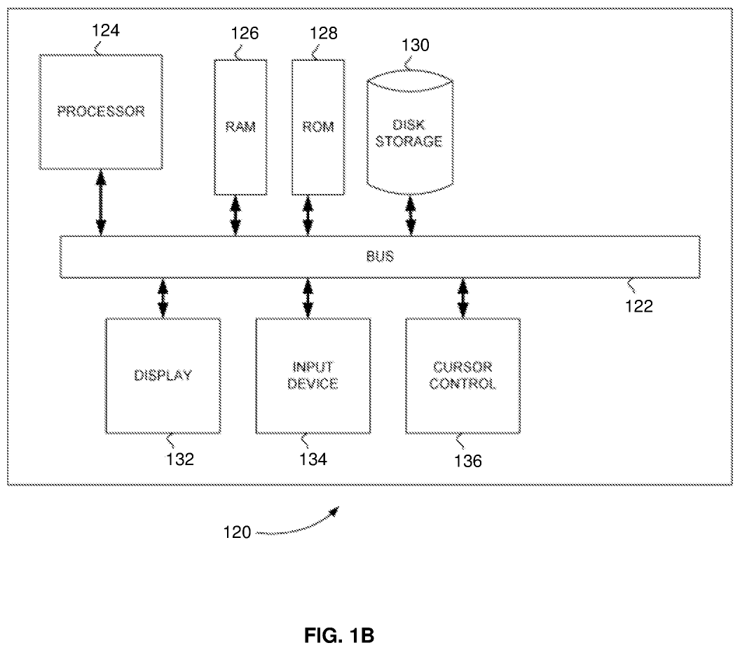

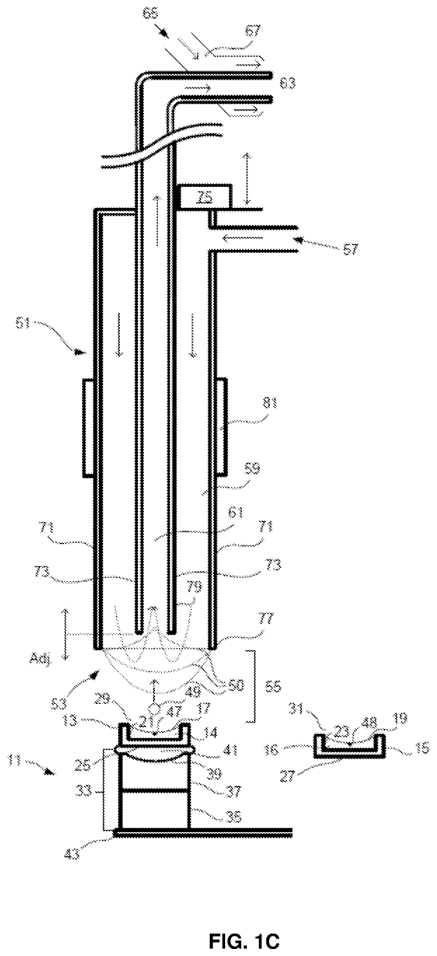

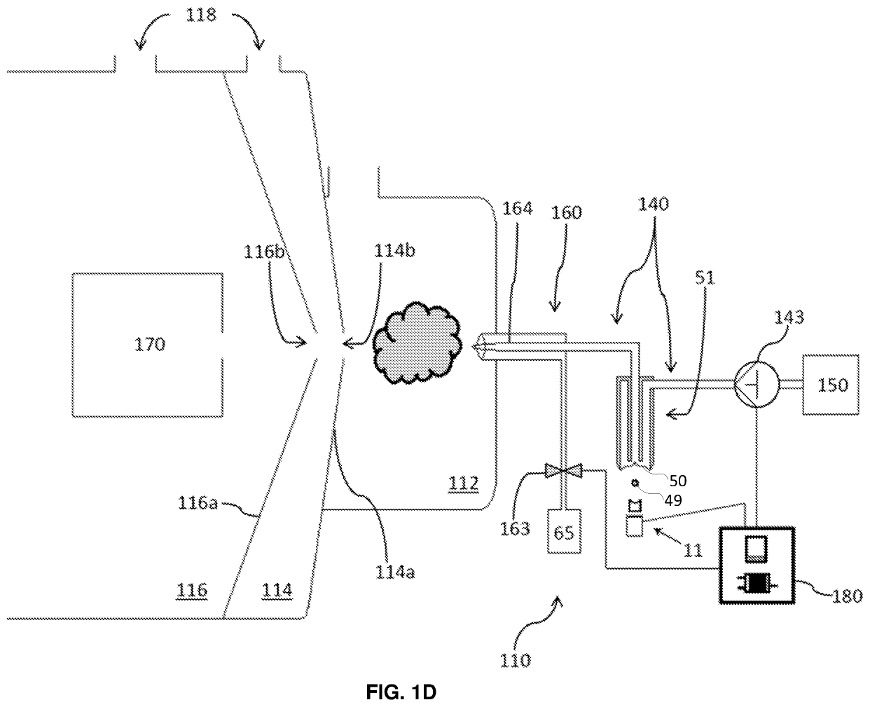

FIG. 1A shows a high level block diagram of a sample processing system according to an embodiment of the disclosure. The sample processing system 100 comprises an analyzer (e.g., an immunoanalyzer) 102, a mass spectrometer 106, and a sample introduction apparatus 104. The sample introduction apparatus 104 may be physically and/or operationally coupled to the analyzer 102 and the mass spectrometer 106, and may form a single instrument in some embodiments. The sample introduction apparatus 104 may serve to transfer processed samples or sample aliquots from the analyzer 102 to the mass spectrometer 106. For example, the sample introduction apparatus 104 may be configured to transfer processed sample aliquots from the analyzer 102 to the mass spectrometer 106.

The analyzer 102 may include a number of sample aliquot processing apparatuses to form processed sample aliquots for analysis. Such processing apparatuses may process a sample or sample aliquot in any suitable manner. Examples of sample aliquot processing apparatuses include reagent addition stations (e.g., reagent pipetting stations), sample pipetting stations, incubators, wash stations (e.g., a magnetic wash station), sample storage units, etc. The plurality of sample aliquot processing apparatuses are capable of processing the first sample aliquot to form the first processed sample aliquot, and capable of processing the second sample aliquot to form the second processed sample aliquot. A “processed sample aliquot” may include a sample aliquot that is processed any suitable number of times by any suitable number of processing apparatuses.

A control system 108 may also be present in the sample processing system 100. The control system 108 may control the analyzer 102, the sample introduction apparatus 104, and/or the mass spectrometer 106. The control system 108 may comprise a data processor 108A, and a non-transitory computer readable medium 108B and a data storage 108C coupled to the data processor 108A. The non-transitory computer readable medium 108B may comprise code, executable by the processor 108A to perform the functions described herein. The data storage 108C may store data for processing samples, sample data, or data for analyzing sample data.

The data processor 108A may include any suitable data computation device or combination of such devices. An example data processor may comprise one or more microprocessors working together to accomplish a desired function. The data processor 108A may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or like processor(s).

The computer readable medium 108B and the data storage 108C may be any suitable device or devices that may store electronic data. Examples of memories may comprise one or more memory chips, disk drives, etc. Such memories may operate using any suitable electrical, optical, and/or magnetic mode of operation.

The computer readable medium 108B may comprise code, executable by the data processor 108A to perform any suitable method. For example, the computer readable medium 108B may comprise code, executable by the processor 108A, to cause the sample processing system perform a method including automated method parameter configuration for differential mobility separations. In yet other embodiments of the invention, the computer readable medium 108B may comprise code, executable by the data processor 108A, to cause the sample processing system to perform a method comprising receiving a sample in an open port interface; diluting and transferring the diluted sample to an ionization source; ionizing the diluted sample; introducing the ionized sample into a mass spectrometer; mass analyzing the ionized sample to produce an initial mass analysis result; determining a peak width of the initial mass analysis result; and determining a dwell time for subsequent measurements based on the determined peak width, a pre-defined number of data points across subsequent mass analysis peak widths, and a number of transitions to different analytes in the sample.

FIG. 1B is a block diagram that illustrates a computer system, upon which embodiments of the present teachings may be implemented. Computer system 120 may comprise a bus 122 or other communication mechanism for communicating information, and a processor 124 coupled with bus 122 for processing information. Computer system 120 may also comprise a memory 126, which may be a random access memory (RAM) or other dynamic storage device, coupled to bus 122 for storing instructions to be executed by processor 124. Memory 126 also may be used for storing temporary variables or other intermediate information during execution of instructions to be executed by processor 124. Computer system 120 may comprise a read only memory (ROM) 128 or other static storage device coupled to bus 122 for storing static information and instructions for processor 124. A storage device 130, such as a magnetic disk or optical disk, may be provided and coupled to bus 102 for storing information and instructions.

Computer system 120 may be coupled via bus 122 to a display 132, such as a light emitting diode (LED) or liquid crystal display (LCD), for displaying information to a computer user. An input device 134, including alphanumeric and other keys, may be coupled to bus 122 for communicating information and command selections to processor 124. Another type of user input device is cursor control 136, such as a mouse, a trackball or cursor direction keys for communicating direction information and command selections to processor 124 and for controlling cursor movement on display 132. This input device typically has two degrees of freedom in two axes, a first axis (i.e., x) and a second axis (i.e., y), that allows the device to specify positions in a plane.

A computer system 120 may perform the present teachings. Consistent with certain implementations of the present teachings, results are provided by computer system 120 in response to processor 124 executing one or more sequences of one or more instructions contained in memory 126. Such instructions may be read into memory 126 from another computer-readable medium, such as storage device 130. Execution of the sequences of instructions contained in memory 126 causes processor 124 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 120 may be connected to one or more other computer systems, like computer system 120, across a network to form a networked system. The network may comprise a private network or a public network such as the Internet. In the networked system, one or more computer systems may store and serve the data to other computer systems. The one or more computer systems that store and serve the data may be referred to as servers or the cloud, in a cloud computing scenario. The one or more computer systems may include one or more web servers, for example. The other computer systems that send and receive data to and from the servers or the cloud may be referred to as client or cloud devices, for example.

The term “computer-readable medium” as used herein refers to any media that participates in providing instructions to processor 124 for execution. Such a medium may take many forms, including but not limited to, non-volatile media, volatile media, and transmission media. Non-volatile media includes, for example, optical or magnetic disks, such as storage device 130. Volatile media includes dynamic memory, such as memory 106. Transmission media includes coaxial cables, copper wire, and fiber optics, including the wires that comprise bus 122.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer may read.

Various forms of computer readable media may be involved in carrying one or more sequences of one or more instructions to processor 124 for execution. For example, the instructions may initially be carried on the magnetic disk of a remote computer. The remote computer may load the instructions into its dynamic memory and send the instructions over a communications link. A modem local to computer system 120 may receive the data on the link and use an infra-red transmitter to convert the data to an infra-red signal. An infra-red detector coupled to bus 122 may receive the data carried in the infra-red signal and place the data on bus 122. Bus 122 carries the data to memory 126, from which processor 124 retrieves and executes the instructions. The instructions received by memory 126 may optionally be stored on storage device 130 either before or after execution by processor 124.

In accordance with various embodiments, instructions configured to be executed by a processor to perform a method may be stored on a computer-readable medium. The computer-readable medium may comprise a device that stores digital information. For example, a computer-readable medium includes a compact disc read-only memory (CD-ROM), universal serial bus (USB) drive, or other storage device as is known in the art for storing software. The computer-readable medium may be accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

In an example scenario, the computer system 120 may be operable to control a mass spectrometer system, such as the system described with respect to FIG. 1C to FIG. 10. Accordingly, the computer system 120 may be operable to control circuitry for configuring the method parameters in mass spectrometry operations. Optimizing method parameters in differential mobility spectrometry (DMS) is not trivial in a high throughput mass spectrometer system. The SelexION® planar DMS is an example of a DMS that provides additional selectivity. Other DMS devices, including curved electrode FAIMS-style DMS devices may also be used for this purpose. In general, the disclosure herein contemplates use of any type of device that offers selectivity based on ion mobility and uses the term DMS to refer to these types of devices.

The difficulty in configuring method parameters is particularly true when trying to analyze a panel of compounds simultaneously. One of the key difficulties is related to method cycle time. A high speed mass spectrometer, such as an Echo® mass spectrometer system, generates data peaks that are quite narrow, where baseline peak widths may typically be less than 2 s. The final peak widths for the Open Port Probe (OPP) depend to a large extent upon operational conditions such as transfer tube dimensions, flow rate, sprayer design, and nebulizer gas flow rate. DMS separations occur at atmospheric pressure and extend the necessary cycle time for analysis of multiple compounds because the DMS parameters are changed and then the instrument optics are refilled (15 ms pause time typical versus the standard 5 ms pause time).

Cycle times for multi analyte methods, such as multiple reaction monitoring (MRM), includes a pause time as well as a dwell time, where dwell time is the period of the overall method cycle in which data is collected for a particular MRM transition. Ion signals are generally measured as count rates (counts per second). Therefore, it is desirable to maximize the dwell time such that the instrument counts the maximum number of ions for a given signal intensity level, where the error is related to the square root of the number of ions counted. This maximizing of dwell time is balanced against a desired number of points across a peak, where shorter dwell times enables more data points across a peak, resulting in better accuracy in determining peak shape and intensity.

On many instruments, the pause time may be fixed for all transitions. When the dwell time is also constant, the total cycle time is thus N(pause+dwell), where N is the total number of transitions that are monitored in the workflow. In an example embodiment of the present disclosure, the functionality to automatically configure the dwell time for panels of compounds with variable numbers of analytes is described.

FIG. 1C is a schematic diagram of a sample introduction apparatus, in accordance with an example embodiment of the disclosure. The system shown in FIG. 1C is an example sample introduction apparatus, in this case acoustic droplet ejection (ADE) device, which is shown generally at 11, ejecting droplet 49 toward the continuous flow sampling probe (referred to herein as an open port interface (OPI)) indicated generally at 51 and into the sampling tip 53 thereof.

The acoustic droplet ejection device 11 includes at least one reservoir, with a first reservoir shown at 13 and an optional second reservoir 31. In some embodiments a further plurality of reservoirs may be provided. Each reservoir is configured to house a fluid sample having a fluid surface, e.g., a first fluid sample 14 and a second fluid sample 16 having fluid surfaces respectively indicated at 17 and 19. When more than one reservoir is used, as illustrated in FIG. 1C, the reservoirs are preferably both substantially identical and substantially acoustically indistinguishable, although identical construction is not a requirement.

The ADE comprises acoustic ejector 33, which includes acoustic radiation generator 35 and focusing element 37 for focusing the acoustic radiation generated at a focal point 47 within the fluid sample, near the fluid surface. As shown in FIG. 1C, the focusing element 37 may comprise a single solid piece having a concave surface 39 for focusing the acoustic radiation, but the focusing element may be constructed in other ways. The acoustic ejector 33 is thus adapted to generate and focus acoustic radiation so as to eject a droplet of fluid from each of the fluid surfaces 17 and 19 when acoustically coupled to reservoirs 13 and 15, and thus to fluids 14 and 16, respectively. The acoustic radiation generator 35 and the focusing element 37 may function as a single unit controlled by a single controller, or they may be independently controlled, depending on the desired performance of the device.

The acoustic droplet ejector 33 may be in either direct contact or indirect contact with the external surface of each reservoir. With direct contact, in order to acoustically couple the ejector to a reservoir, it is preferred that the direct contact be wholly conformal to ensure efficient acoustic energy transfer. That is, the ejector and the reservoir should have corresponding surfaces adapted for mating contact. Thus, if acoustic coupling is achieved between the ejector and reservoir through the focusing element, it is desirable for the reservoir to have an outside surface that corresponds to the surface profile of the focusing element. Without conformal contact, efficiency and accuracy of acoustic energy transfer may be compromised. In addition, since many focusing element have a curved surface, the direct contact approach may necessitate the use of reservoirs that have a specially formed inverse surface.

Optimally, acoustic coupling is achieved between the ejector and each of the reservoirs through indirect contact, as illustrated in FIG. 1C. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing element 37 and the underside of the reservoir. In addition, it is important to ensure that the fluid medium is substantially free of material having different acoustic properties than the fluid medium itself. As shown, the first reservoir 13 is acoustically coupled to the acoustic focusing element 37 such that an acoustic wave generated by the acoustic radiation generator is directed by the focusing element 37 into the acoustic coupling medium 41, which then transmits the acoustic radiation into the reservoir 13.

In operation, reservoir 13 and optional reservoir 15 of the device are filled with first and second fluid samples 14 and 16, respectively, as shown in FIG. 1C. The acoustic ejector 33 is positioned just below reservoir 13, with acoustic coupling between the ejector and the reservoir provided by acoustic coupling medium 41. Initially, the acoustic ejector is positioned directly below sampling tip 53 of OPI 51, such that the sampling tip faces the surface 17 of the fluid sample 14 in the reservoir 13. Once the ejector 33 and reservoir 13 are in proper alignment below sampling tip 53, the acoustic radiation generator 35 is activated to produce acoustic radiation that is directed by the focusing element 37 to a focal point 47 near the fluid surface 17 of the first reservoir. As a result, droplet 49 is ejected from the fluid surface 17 toward and into the liquid boundary 50 at the sampling tip 53 of the OPI 51, where it combines with solvent in the flow probe 53. The profile of the liquid boundary 50 at the sampling tip 53 may vary from extending beyond the sampling tip 53 to projecting inward into the OPI 51. In a multiple-reservoir system, the reservoir unit (not shown), e.g., a multi-well plate or tube rack, may then be repositioned relative to the acoustic ejector such that another reservoir is brought into alignment with the ejector and a droplet of the next fluid sample may be ejected. The solvent in the flow probe cycles through the probe continuously, minimizing or even eliminating “carryover” between droplet ejection events. Fluid samples 14 and 16 are samples of any fluid for which transfer to an analytical instrument is desired, where the term “fluid” is as defined earlier herein.

The structure of OPI 51 is also shown in FIG. 1C. Any number of commercially available continuous flow sampling probes may be used as is or in modified form, all of which, as is well known in the art, operate according to substantially the same principles. As can be seen in the FIG. 1C, the sampling tip 53 of OPI 51 is spaced apart from the fluid surface 17 in the reservoir 13, with a gap 55 therebetween. The gap 55 may be an air gap, or a gap of an inert gas, or it may comprise some other gaseous material; there is no liquid bridge connecting the sampling tip 53 to the fluid 14 in the reservoir 13. The OPI 51 includes a solvent inlet 57 for receiving solvent from a solvent source and a solvent transport capillary 59 for transporting the solvent flow from the solvent inlet 57 to the sampling tip 53, where the ejected droplet 49 of analyte-containing fluid sample 14 combines with the solvent to form an analyte-solvent dilution. A solvent pump (not shown) is operably connected to and in fluid communication with solvent inlet 57 in order to control the rate of solvent flow into the solvent transport capillary and thus the rate of solvent flow within the solvent transport capillary 59 as well.

Fluid flow within the OPI 51 carries the analyte-solvent dilution through a sample transport capillary 61 provided by inner capillary tube 73 toward sample outlet 63 for subsequent transfer to an analytical instrument. In a preferred embodiment, a positive displacement pump is used as the solvent pump, e.g., a peristaltic pump, and, instead of a sampling pump, an aspirating nebulization system may be used so that the analyte-solvent dilution is drawn out of the sample outlet 63 by the Venturi effect caused by the flow of the nebulizing gas introduced from a nebulizing gas source 65 via gas inlet 67 (shown in simplified form in FIG. 1C, insofar as the features of aspirating nebulizers are well known in the art) as it flows over the outside of the sample outlet 63.

The analyte-solvent dilution flow is then drawn upward through the sample transport capillary 61 by the pressure drop generated as the nebulizing gas passes over the sample outlet 63 and combines with the fluid exiting the sample transport capillary 61. A gas pressure regulator may be used to control the rate of gas flow into the system via gas inlet 67. In an example manner, the nebulizing gas flows over the outside of the sample transport capillary 61 at or near the sample outlet 63 in a sheath flow type manner which draws the analyte-solvent dilution through the sample transport capillary 61 as it flows across the sample outlet 63 that causes aspiration at the sample outlet upon mixing with the nebulizer gas.

The solvent transport capillary 59 and sample transport capillary 61 are provided by outer capillary tube 71 and inner capillary tube 73 substantially co-axially disposed therein, where the inner capillary tube 73 defines the sample transport capillary, and the annular space between the inner capillary tube 73 and outer capillary tube 71 defines the solvent transport capillary 59.

The system may also comprise an adjuster 75 coupled to the outer capillary tube 71 and the inner capillary tube 73. The adjuster 75 may be adapted for moving the outer capillary tube tip 77 and the inner capillary tube tip 79 longitudinally relative to one another. The adjuster 75 may be any device capable of moving the outer capillary tube 71 relative to the inner capillary tube 73. Exemplary adjusters 75 may comprise motors including, but are not limited to, electric motors (e.g., AC motors, DC motors, electrostatic motors, servo motors, etc.), hydraulic motors, pneumatic motors, translational stages, and combinations thereof. As used herein, “longitudinally” refers to an axis that runs the length of the probe 51, and the inner and outer capillary tubes 73, 71 may be arranged coaxially around a longitudinal axis of the probe 51, as shown in FIG. 1C. Additionally, as illustrated in FIG. 1C, the OPI 51 may be generally affixed within an approximately cylindrical holder 81, for stability and ease of handling.

It should be noted that the ADE described above is just an example and other forms of ejectors, including pneumatic, for example, could be used to introduce samples to the OPI.

FIG. 1D schematically depicts an embodiment of a droplet injection and ionization system 110, in accordance with an example embodiment of the disclosure. The system 110 may be suitable for ionizing and mass analyzing analytes received within an open end of a sampling probe 51, the system 110 including an acoustic droplet injection device 11 configured to inject a droplet 49, from a reservoir into the open end of the sampling probe 51. As shown in FIG. 1D, the system 110 generally includes a sampling probe 51 (e.g., an open port probe) in fluid communication with a nebulizer-assisted ion source 160 for discharging a liquid containing one or more sample analytes (e.g., via electrospray electrode 164) into an ionization chamber 112, and a mass analyzer 170 in fluid communication with the ionization chamber 112 for downstream processing and/or detection of ions generated by the ion source 160. A fluid handling system 140 (e.g., including one or more pumps 143 and one or more conduits) may provide for the flow of liquid from a solvent reservoir 150 to the sampling probe 51 and from the sampling probe 51 to the ion source 160.

The solvent reservoir 150 (e.g., containing a liquid, desorption solvent) may be fluidly coupled to the sampling probe 51 via a supply conduit through which the liquid may be delivered at a selected volumetric rate by the pump 143 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of liquid into and out of the sampling probe 51 occurs within a sample space accessible at the open end such that one or more droplets may be introduced into the liquid boundary 50 at the sample tip 53 and subsequently delivered to the ion source 160.

As shown, the system 110 includes an acoustic droplet injection device 11 that is configured to generate acoustic energy that is applied to a liquid contained with a reservoir (as depicted in FIG. 1C) that causes one or more droplets 49 to be ejected from the reservoir into the open end of the sampling probe 51. A controller 180 may be operatively coupled to the acoustic droplet injection device 11 and configured to operate any aspect of the acoustic droplet injection device 11 (e.g., focusing, acoustic radiation generator, automatically positioning one or more reservoirs into alignment with the acoustic radiation generator, etc.) so as to inject droplets into the sampling probe 51 or otherwise discussed herein substantially continuously or for selected portions of an experimental protocol by way of non-limiting example.

In an example scenario, the sample volume may be 1-50 nL. The plurality of sample pulses may be delivered at a rate of at least one sample pulse per five seconds. The plurality of sample ion pulses may be transferred to the mass spectrometer in less than about 100 seconds, or alternatively may be transferred to the mass spectrometer in less than 15 seconds. The plurality of sample ion pulses may comprise five to ten sample volumes transferred to the mass spectrometer in a range of about 0.5 seconds to 15 seconds.

As shown in FIG. 1D, the exemplary ion source 160 may include a source 65 of pressurized gas (e.g. nitrogen, air, or a noble gas) that supplies a high velocity nebulizing gas flow which surrounds the outlet end of the electrospray electrode 164 and interacts with the fluid discharged therefrom to enhance the formation of the sample plume and the ion release within the plume for sampling by 114b and 116b, e.g., via the interaction of the high speed nebulizing flow and jet of liquid sample (e.g., analyte-solvent dilution).

The nebulizer gas may be supplied at a variety of flow rates, for example, in a range from about 0.1 L/min to about 20 L/min, which may also be controlled under the influence of controller 180 (e.g., via opening and/or closing valve 163). In accordance with various aspects of the present teachings, it will be appreciated that the flow rate of the nebulizer gas may be adjusted (e.g., under the influence of controller 180) such that the flow rate of liquid within the sampling probe 51 may be adjusted based, for example, on suction/aspiration force generated by the interaction of the nebulizer gas and the analyte-solvent dilution as it is being discharged from the electrospray electrode 164 (e.g., due to the Venturi effect).

In the depicted embodiment, the ionization chamber 112 may be maintained at an atmospheric pressure, though in some embodiments, the ionization chamber 112 may be evacuated to a pressure lower than atmospheric pressure. The ionization chamber 112, within which the analyte may be ionized as the analyte-solvent dilution is discharged from the electrospray electrode 164, is separated from a gas curtain chamber 114 by a plate 114a having a curtain plate aperture 114b. As shown, a vacuum chamber 116, which houses the mass analyzer 170, is separated from the curtain chamber 114 by a plate 116a having a vacuum chamber sampling orifice 116b. The curtain chamber 114 and vacuum chamber 116 may be maintained at a selected pressure(s) (e.g., the same or different sub-atmospheric pressures, a pressure lower than the ionization chamber) by evacuation through one or more vacuum pump ports 118.

It will also be appreciated by a person skilled in the art and in light of the teachings herein that the mass analyzer 170 may have a variety of configurations. Generally, the mass analyzer 170 is configured to process (e.g., filter, sort, dissociate, detect, etc.) sample ions generated by the ion source 160. By way of non-limiting example, the mass analyzer 170 may be a triple quadrupole mass spectrometer, or any other mass analyzer known in the art and modified in accordance with the teachings herein. Other non-limiting, exemplary mass spectrometer systems that may be modified in accordance various aspects of the systems, devices, and methods disclosed herein may be found, for example, in an article entitled “Product ion scanning using a Q-q-Qlinear ion trap (Q TRAP®) mass spectrometer,” authored by James W. Hager and J. C. Yves Le Blanc and published in Rapid Communications in Mass Spectrometry (2003; 17: 1056-1064), and U.S. Pat. No. 7,923,681, entitled “Collision Cell for Mass Spectrometer,” which are hereby incorporated by reference in their entireties.

Other configurations, including but not limited to those described herein and others known to those skilled in the art, may also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements may be included in the system 110 including, for example, an ion mobility spectrometer (e.g., a differential mobility spectrometer) that is disposed between the ionization chamber 112 and the mass analyzer 170 and is configured to separate ions based on the difference in mobility through a drift gas in high- and low-fields rather than their mass-to-charge ratio). Additionally, it will be appreciated that the mass analyzer 170 may comprise a detector that can detect the ions that pass through the analyzer 170 and may, for example, supply a signal indicative of the number of ions per second that are detected.

In an example embodiment of the disclosure, the periodic introduction of samples enabled by the system 110 may be utilized to improve signal integrity through signal processing techniques that capitalize on the known and pre-defined time-dependent nature of the signal of interest. For example, periodic signals from regular introduction of samples to the mass analyzer 170 enable Fourier Transform operations on the data resulting in a frequency-dependent signal that may then be filtered to remove any frequencies not at the frequency corresponding to the timing of the sample ion introduction. In addition, inverse Fourier Transform operations may be performed on the filtered frequency-dependent signals to generate cleaned up time-dependent signals if desired.

Similarly, de-noising techniques may be utilized on aperiodic signals with pre-determined timing, such that signals that are within and outside those timing windows may be removed or ignored. The de-noising may comprise selectively rejecting any signal not following the pre-determined time pattern. In addition, pulse-based signal averaging may be performed in the known signal timing windows to increase signal measurement accuracy. In another example, desired signal isolation may be obtained by the deconvolution of frequency components of the detected signal where the analyte signal may be isolated by evaluating a pulse frequency component corresponding to the expected pattern of pulses.

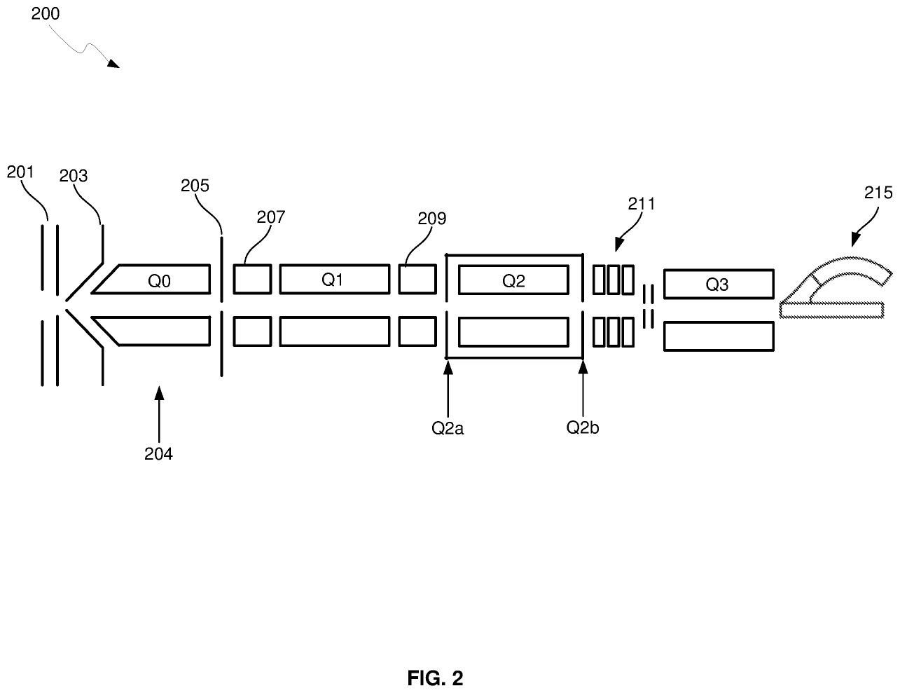

FIG. 2 is a schematic diagram of a mass spectrometer system, in accordance with an example embodiment of the disclosure. Referring to FIG. 2, there is shown mass spectrometer 200 comprising quadrupoles Q0, Q1, Q2, and Q3, orifice plates 201 and 205, skimmer 203, additional stubby rods 207 and 209, focusing lens 211, and detector 215.

The quadrupoles Q0-Q3 comprise four electrodes/poles that may be biased with DC and/or AC voltages for capturing, confining, and ejecting charged ions. The electrodes may be cylindrical or may have a hyperbolic shape, for example. The orifice plates 201 and 205 may comprise plates with an orifice formed therein for allowing ions to pass through but with the orifice being small enough to enable a pressure difference between chambers, such as between vacuum chamber 204 and other higher pressure regions of the mass spectrometer 200.

The stubby rods 207 and 209 may comprise shorter rods, as compared to Q0-Q3, that guide ions between Q0 and Q3, and may also be biased with DC and/or RF fields for transporting ions confined along a central axis. The detector 215 may comprise a channel electron multiplier (CEM), for example. An electron multiplier may be used to detect the presence of ion signals emerging from Q3, where an ion strikes a surface it causes secondary electrons to be released from atoms in the surface layer. These electrons cause an electron cascade, thereby generating an output signal. Other detection techniques are possible within the context of this disclosure.

During operation of the mass spectrometer 200, ions may be admitted into vacuum chamber 204 through orifice plates 201 and skimmer 203. Ions may be collisionally cooled in Q0, which may be maintained at a low pressure, such as less than 100 mTorr, for example. Quadrupole Q1 may operate as transmission RF/DC quadrupole mass filter, and may be segmented for injecting highly confined ion packets into Q2. Q2 may comprise a collision cell in which ions collide with a collision gas, such as nitrogen, for example, to be fragmented into products of lesser mass. Ions may be trapped radially in any of Q0, Q1, Q2, and Q3 by RF voltages applied to the rods and axially by DC voltages applied to the end aperture lenses or orifice plates. In addition, Q2 may comprise orifice plates Q2a and Q2b to enable a pressure difference between the higher pressure of Q2 and other regions of mass spectrometer 200.

According to aspects of the present disclosure, an auxiliary RF voltage may be provided to end rod segments, end lenses, and/or orifice plates of one of the rod sets to provide a pseudo potential barrier. In this way, both positive and negative ions may be trapped within a single rod set or cell. Typically, positive and negative ions would be trapped within the high pressure Q2 cell. Once the positive and negative ions within Q2 have reacted, they may be transferred to Q3. Typically, multiple reaction monitoring (MRM) can mode is performed by triple quadrupole mass spectrometer, as shown. Sample ions are first mass filtered for a parent compound mass in Q1. The selected ions may then be fragmented in a controlled way in Q2 and a specific fragment ion or ions are detected by Q3. This process allows a highly specific detection and quantitation of analyte ions without being hindered by high background signals from endogenous species also present in the sample. This may be repeated as more samples are introduced into the mass spectrometer 200 for analysis. Furthermore, any of the quadrupoles Q1-Q3 may have ion detection capability such that MS and MS/MS scans are enabled.

The present disclosure provides techniques for improving mass spectrometer signals as compared to background signals through processing measured signals with a predetermined pattern, such as a periodic signal, for example. In one example, the sample introduction at regular intervals provided by the sample introduction apparatus described in FIGS. 1A-1D enables the use of time series analysis for signal recovery, thus offering signal definition improvement. A sample aliquot may be delivered for mass spectrometer analysis at regular intervals forming a time series. In instances where the time interval is determined by the operator, it is thus known and well defined, and the signal will appear only at that frequency. Therefore, in one embodiment, Fourier analysis may be used to deconvolve the signal from the time-domain to the frequency domain, where a suitable narrow band pass filter may be applied at the carrier (generating or sample introduction) frequency, enabling the removal of all other frequency components as noise, potentially enabling the recovery of signals “lost in the baseline”. The magnitude of this remaining signal, in the filter band pass that corresponds to the pre-determined time pattern of the ion pulses, may be measured to obtain a more accurate ion count determination. This process may provide an order of magnitude improvement in signal recovery.

In another embodiment, the remaining frequency component, at the carrier or sample introduction frequency, may be converted back into the time-domain.

There may be trade-offs between the length of the time series (duration) and related signal improvement, where longer time series may offer higher accuracy but may reduce throughput. The finite nature of the time series may be compensated for by an appropriate “windowing” of the time data. In addition, the “square” nature of the signal pulse differs from the sinusoidal wave form of standard Fourier analysis, but this may be considered in the analysis, which in one embodiment comprises a Fast Fourier Transform (FFT) or discrete Fourier Transform (DFT). This approach may also be applied to a time series of single pulses, each of different intensity, but generated at a given frequency. In this case, the frequency domain representation of the signal may not be as unique, rendering less efficient filtering, but the result may still provide higher signal-to-noise ratio than conventional MS techniques.

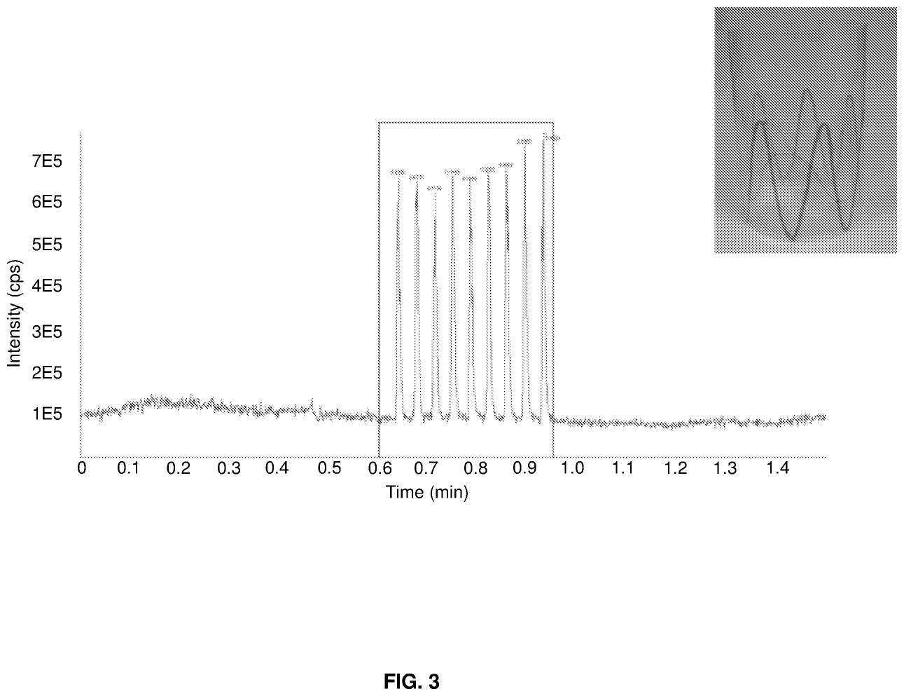

FIG. 3 illustrates example sample pulses in a mass spectrometer, in accordance with an example embodiment of the disclosure. Referring to FIG. 3, there is shown a mass spectrometer signal resulting from nine ion pulses introduced to a mass spectrometer using a sample introduction apparatus and mass spectrometer as described in FIGS. 1A-2. The data covers a 1.5 minute timeframe with a time window around the nine pulses shown in FIG. 3.

In this periodic segment of the MRM signal, nine injections occurring at 0.45 Hz are shown, where both amplitude, frequency and phase may be considered in the signal processing. Acoustic droplet firing time and transit are known and configured by the sample introduction apparatus, enabling the calculations. The nine injection interval may be isolated such that it is nine periods long, where the frequency space representation of the components may be complex numbers.

The signal pulse train, with its length made up by a full period shown by the time window in FIG. 3, may be wrapped around to form an “infinite” periodic function by joining the last injection to the first while correctly spacing (by the period of the carrier frequency) the first and last peaks in the loop (wrap). In one embodiment, an FFT routine may be used, where the total number of points is a power of 2, which is 512 in this example. The frequency step, or resolution, may be determined by the sampling frequency divided by the number of data points. The process may be improved by programming and optimizing the steps, i.e., the number of pulses in the train, the sampling rate for carrier isolation, and transform optimization, where factors such as odd harmonics, higher order terms, and breaking down into other functions may be configured depending on the desired signal to noise, processing speed, and throughput, for example.

The Fourier Transform operation may return a complex component at each of the discrete frequencies, where each component may resemble a sinusoid as shown by the two traces in the inset in FIG. 3. The imaginary part of the complex component comprises the phase of that sinusoid in the time-domain, where the phase may be important if reconstructing the time-domain signal. However, in this case it is not of interest to integrate the cleaned up peaks in the time-domain signal, but instead to evaluate the power/energy in the frequency domain at the signal carrier/sample introduction frequency, because this amplitude does not change with the phase offset, i.e., each trace may be rotated but its amplitude will not change. The amplitude is given by the modulus of the complex component, which is real and quantitatively represents the amount of analyte generating the MRM signal. All other frequency components may be ignored, as they comprise noise and do not carry the desired signal.

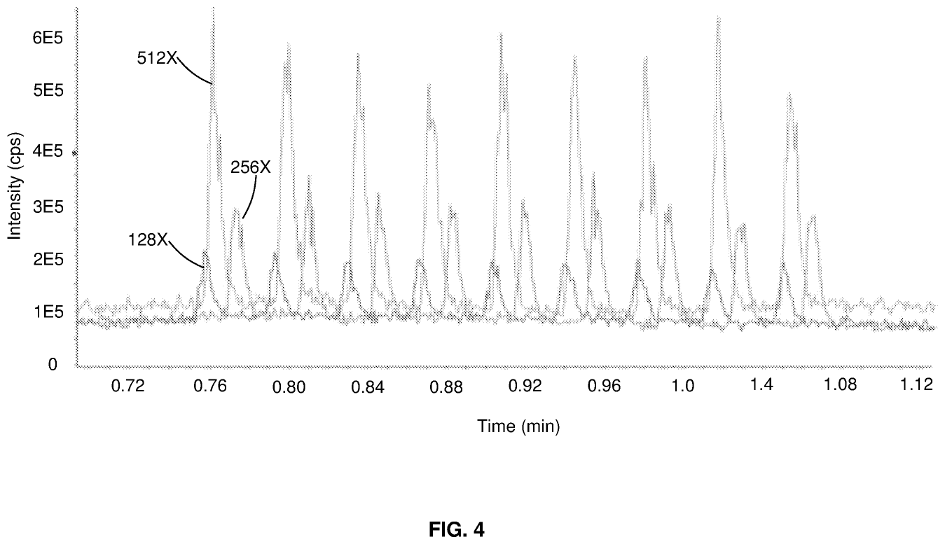

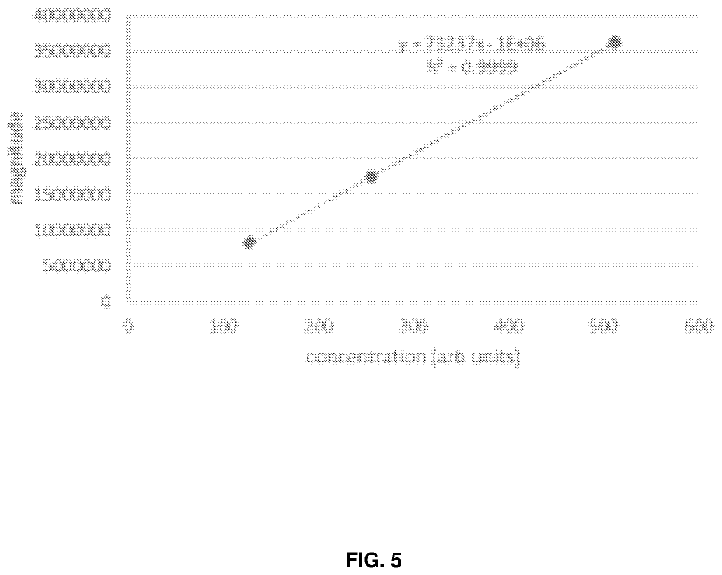

FIG. 4 illustrates a time-dependent ion count measurement for three concentrations, in accordance with an example embodiment of the disclosure. Referring to FIG. 4, there is shown ion count signals for three concentrations, labeled 128×, 256×, and 512×, each comprising nine pules at 0.45 Hz. As can be seen in the plots, each signal has variation in the peak value despite the concentration being the same for each pulse, indicating the room for improvement in ion count accuracy at this concentration. Performing a Fourier Transform on the time-domain signals, filtering out signals not at the 0.45 Hz frequency, and measuring the intensity of the remaining signal, results in a single magnitude for each concentration (based on the nine injections) as shown in FIG. 5.

FIG. 5 illustrates mass analysis results at various concentrations following Fourier transform analysis, in accordance with an example embodiment of the disclosure. Referring to FIG. 5, there is shown three data points for a factor of two calibration curve, where each concentration is a factor of two dilution of the previous level. The three data points shown are the top end three concentrations (512×, 256× and 128× respectively, arbitrary units used) each comprising nine injections at 0.45 Hz, where the y-axis is the magnitude of the carrier frequency component corresponding to the ion count signal of the nine injections and the x-axis is the corresponding concentration. As expected, the magnitude increases for higher concentrations and has excellent linearity as indicated by the linear interpolation shown by the dashed line, resulting in an R² of 0.9999.

The magnitudes shown were calculated using a nine-pulse pre-determined timing of 0.45 Hz in a Fourier analysis to generate a frequency-dependent signal with frequencies not at the 0.45 Hz frequency being ignored. The resulting data is therefore due to the desired ion count signal. In this manner, background noise may be significantly reduced and an accurate result may be obtained at each concentration, in contrast to the varying peak intensities in FIG. 4.

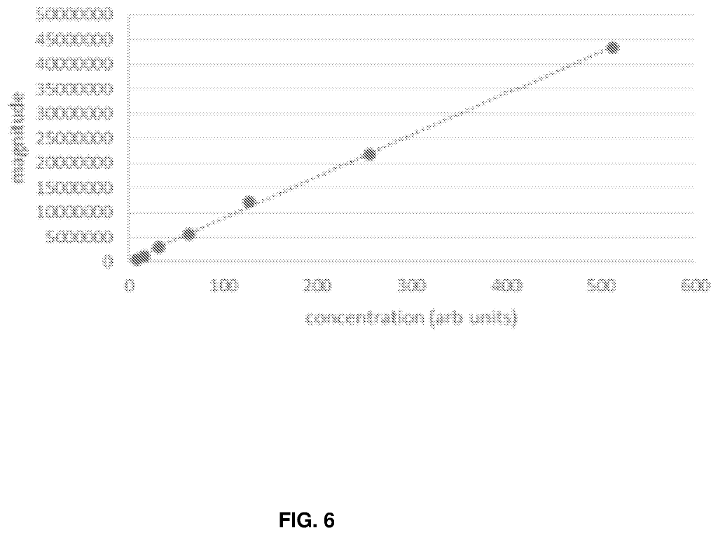

FIG. 6. illustrates a carrier frequency magnitude versus concentration plot in an eight point calibration, in accordance with an example embodiment of the disclosure. Referring to FIG. 6, there is shown a plot of a carrier frequency magnitude generated from 9-injection sequences at 0.45 Hz for each of the eight concentrations. Again, a factor of two dilution may be used to prepare the different concentration levels. As evidenced by the linear interpolation of the data points, the calibration is linear all the way down to very low concentrations near zero. Therefore, a desired analyte signal may be isolated by signal conditioning the ion-count generated signal, where the signal conditioning is based on the pre-determined time pattern of the sample injection, which may be a droplet or other form such as injection (flow injection analysis (FIA) or fast liquid chromatography (LC)). In this case the pre-determined time pattern is a periodic signal. This may greatly improve linearity and accuracy, where in this example, the periodic introduction of samples allows Fourier Transform analysis on the data points.

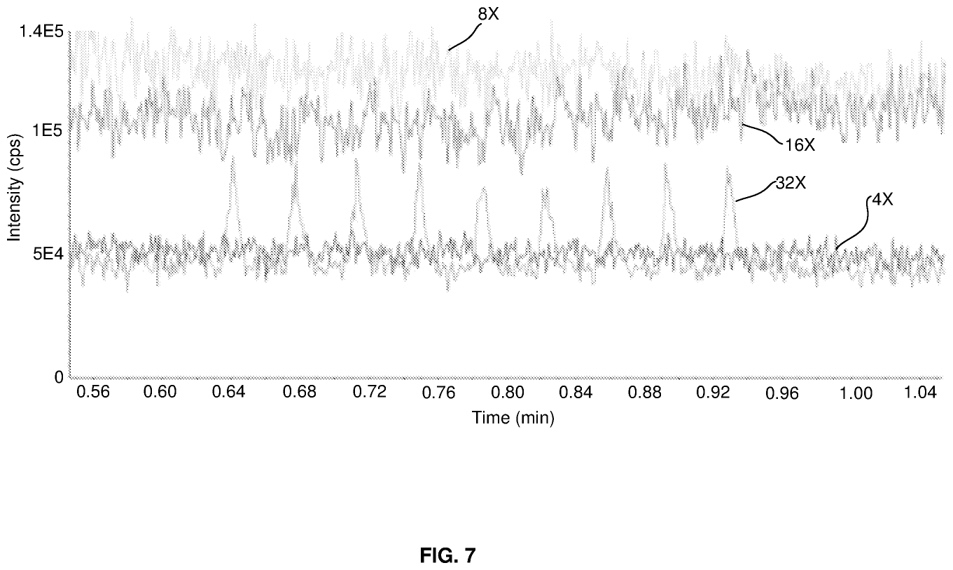

FIG. 7 illustrates ion count data versus time for different concentration samples, in accordance with an example embodiment of the disclosure. Referring to FIG. 7, there is shown a plot with the y-axis representing ion counts in counts/sec and the x-axis being time. The four signals, labeled 4×, 8×, 16×, and 32×, represent different concentration sample calibrations in a factor of two calibration with 9 injection pulses each at 0.45 Hz. The four signals correspond to the low end of the calibration curve shown in FIG. 6. For clarity, the 8×× and 16×× signals have been offset vertically to differentiate the signals.

As shown in the plots, lower concentrations result in lower signals and vanishing peak definition, as expected, and at the lowest concentrations, signal peaks may be lost in the noise, which is seen in the 4×× and 8×× signals. Signal processing based on the pre-determined pattern of pulses may be utilized to recover signals masked by noise. Because these sample pulses are periodic, FFT/DFT signal processing may be utilized to extract the desired analyte signal, transforming the time-domain signals to frequency domain signals, where the magnitude of the frequency domain signal at the carrier frequency, i.e., the frequency of the sample introduction, represents the presence of the desired analyte. The magnitude may comprise the modulus of the complex number at the specific carrier frequency in the calculated frequency domain.

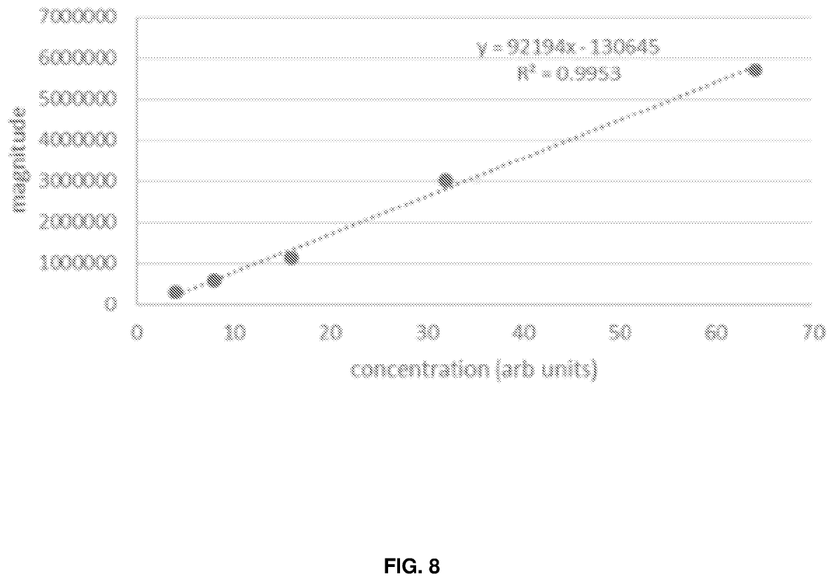

FIG. 8 illustrates carrier frequency count magnitude for discrete Fourier transform processed calibration signals, in accordance with an example embodiment of the disclosure. Referring to FIG. 8, there is shown magnitude results for five different concentrations, where each magnitude qualitatively maps onto its concentration, the lowest four corresponding to the four time-domain signals shown in FIG. 7. The linearity is excellent even all the way down to the lowest concentrations, where a signal magnitude is calculated for the 4× signal in FIG. 7, even though no discernible peaks are present in the time-domain signal.

Therefore, the signal processing of pre-determined pulse patterns for mass spectrometer sample introduction described here enables the identification of the presence of an analyte even to very low concentrations, well below where signal peaks are similar in magnitude to background noise. This is possible even with pulses on the order of a second.

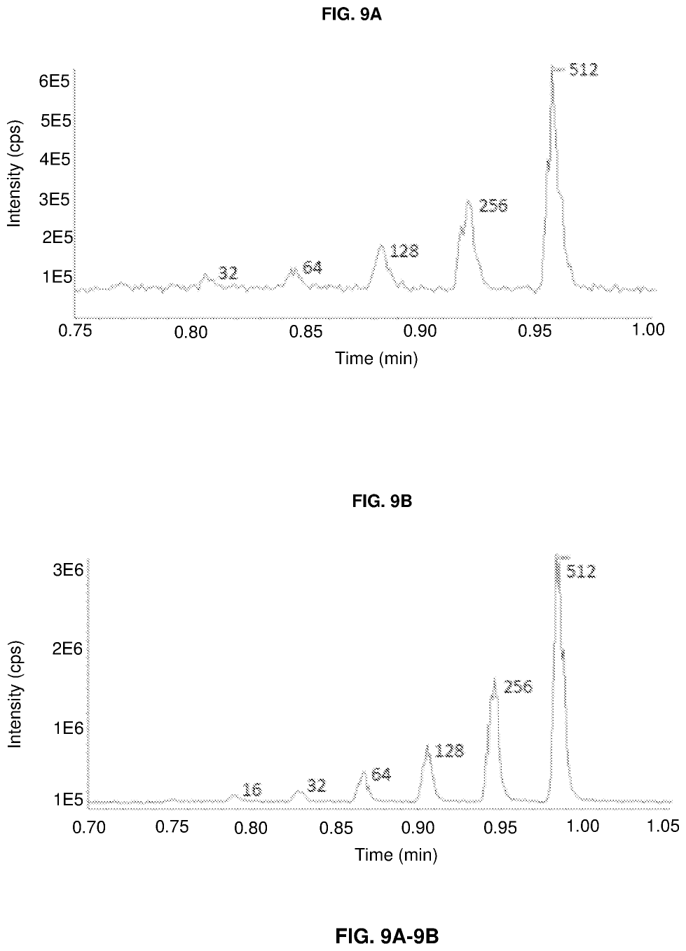

FIGS. 9A and 9B illustrate time domain multiple reaction monitoring (MRM) signal generated by a mass spectrometer for an analyte of interest, in accordance with an example embodiment of the disclosure. FIGS. 9A and 9B are for single droplets and multiple merged droplets, respectively. Referring to FIG. 9A, there is shown an MRM signal for a single 5 nL droplet at each concentration, and in FIG. 9B, an MRM signal is shown for nine 5 nL droplets merged into a single peak, i.e., each pulse is adjacent to the next pulse without any time between. As shown in the plots, the peaks are at the noise level for concentrations below 32× in the single droplet case and below ˜16× for the combined pulse. However, using DFT/FFT processing on a single 5 nL droplet enables readings at concentrations 8 to 10 times lower compared to the single droplet and 2 to 4 times lower than the merged droplet pulses.

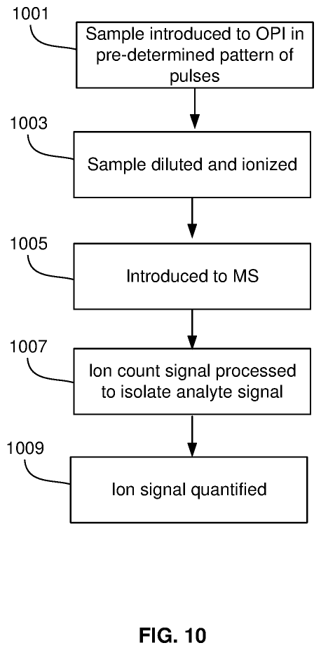

FIG. 10 is a flow diagram illustrating mass spectrometry with a pre-determined pattern sample introduction and signal processing, in accordance with an example embodiment of the disclosure. The process begins in step 1001 where a sample is introduced to an OPI in a predetermined pattern using an acoustic droplet ejector, where the pre-determined pattern may comprise a periodic sample introduction, for example. In step 1003, the sample may be diluted in the OPI and ionized before being introduced into the mass spectrometer in step 1005 In an example embodiment a number of periodic pulses may be introduced, with a known number of pulses at a known frequency and pulse width.

In step 1007, the ion count signal in the detector in the mass spectrometer may be signal processed to identify the desired analyte signal. For example, with a periodic sample introduction, a Fourier Transform may be performed on the signal to generate a frequency-domain signal. The frequency-domain signal may be analyzed to determine a signal at the carrier frequency, the frequency at which the samples were introduced. In another example, the signal conditioning comprises a deconvolution of frequency components of the generated signal and the analyte signal may be isolated by evaluating a pulse frequency component corresponding to the pre-determined time pattern. In another example embodiment, the signal conditioning may comprise de-noising, which may comprise selectively rejecting any signal not following the pre-determined time pattern.

In another example, the signal conditioning may comprise: identifying an initial ion pulse; windowing the generated signal based on the initial ion pulse and the pre-determined time pattern; and summing the windows to generate a sum of detected ion pulses; and identifying the presence of the analyte based on the sum of detected ion pulses as compared to a threshold value. In yet another example, the signal conditioning may comprise: identifying an initial ion pulse; identifying a background signal based on the initial ion pulse and the pre-determined time pattern; and subtracting the background signal from the subsequently generated signal.

In step 1009, the ion signal may be quantified at the sample frequency or at the pulse frequency component that corresponds to the pre-determined pattern. In a Fourier Transform, such as a DFT, a magnitude of the complex number representing the frequency-domain signal at the frequency of interest may be calculated, while other frequencies may be ignored, the magnitude of the complex value corresponding to the desired ion count.

A system and/or method for timed introduction of sample into a mass spectrometer implemented in accordance with various aspects of the present disclosure, for example, provides receiving a plurality of sample ion pulses in a mass spectrometer from a sampling interface, the sample ion pulses received at a pre-determined time pattern; detecting the received sample ion pulses in the mass spectrometer to generate a signal; isolating an analyte signal by signal conditioning the generated signal based on the pre-determined time pattern; and identifying a presence of an analyte based on the isolated analyte signal. The signal conditioning may comprise pulse-based averaging based on the pre-determined time pattern.

The pre-determined time pattern may result in sample ion pulses occurring at a specific carrier frequency. The signal conditioning may comprise converting the generated signal to a frequency-domain signal and calculating a modulus of only the carrier frequency, or a defined bandwidth around the carrier frequency, to isolate the analyte signal. The presence of the analyte may be identified by determining whether the modulus exceeds a threshold value. The identifying the presence of the analyte may comprise quantitating an amount of analyte present in the sample ion pulses. The pre-determined time pattern may be periodic where the signal conditioning comprises performing a Fourier Transform on the signal to convert it to a frequency-domain signal. The frequency domain signal may be filtered of any frequencies outside of a configured bandwidth centered at a frequency corresponding to the periodic pre-determined time pattern.

The signal conditioning may comprise a deconvolution of frequency components of the generated signal. The analyte signal may be identified by evaluating a pulse frequency component corresponding to the pre-determined time pattern. A magnitude of the pulse frequency component may be used to identify the presence of the analyte. The identifying the presence of the analyte may comprise quantitating an amount of analyte present in the sample ion pulses.

The signal conditioning may comprise de-noising, which may comprise selectively rejecting any signal not following the pre-determined time pattern. The signal conditioning may comprise: identifying an initial ion pulse; windowing the generated signal based on the initial ion pulse and the pre-determined time pattern; summing the windows to generate a sum of detected ion pulses; and identifying the presence of the analyte based on the sum of detected ion pulses as compared to a threshold value. The signal conditioning may comprise: identifying an initial ion pulse; identifying a background signal based on the initial ion pulse and the pre-determined time pattern; and subtracting the background signal from the generated signal. The amount of analyte present in the sample ion pulses may be quantified by determining a concentration of analyte present in a sample that produced the sample ion pulses. The sample may be re-tested when the presence of the analyte is identified. In one example, the sample may be re-tested using Liquid Chromatography Mass Spectrometry (LC-MS).

The sampling interface may comprise an acoustic drop ejector-open port interface (ADE-OPI). In other examples, the sampling interface may comprise electrospray ionization (ESI), atmospheric pressure chemical ionization (APCI), atmospheric pressure photoionization (APPI), or a matrix-assisted laser desorption/ionization (MALDI) interface, or any sample introduction technique capable of introducing samples at configured times. The sampling interface may comprises an acoustic droplet ejector and each sample volume may comprise one or more sample droplets. The sample volume may comprise 1-50 nL. The plurality of sample pulses may be delivered at a rate of at least one sample pulse per five seconds. The plurality of sample ion pulses may be transferred to the mass spectrometer in less than about 100 seconds, or alternatively may be transferred to the mass spectrometer in less than 15 seconds. The plurality of sample ion pulses may comprise five to ten sample volumes transferred to the mass spectrometer in a range of about 0.5 seconds to 15 seconds.

While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

1. A method for mass spectrometry, the method comprising:
receiving a plurality of sample ion pulses in a mass spectrometer from a sampling interface, the sample ion pulses received at a pre-determined time pattern;
detecting the received sample ion pulses in the mass spectrometer to generate a signal;
isolating an analyte signal by signal conditioning the generated signal based on the pre-determined time pattern; and
identifying a presence of an analyte based on the isolated analyte signal.

2. The method according to claim 1, wherein the signal conditioning comprises pulse-based averaging based on the pre-determined time pattern.

3. The method according to claim 1, wherein the pre-determined time pattern results in sample ion pulses occurring at a specific carrier frequency.

4. The method according to claim 3, wherein the signal conditioning comprises converting the generated signal to a frequency-domain signal and calculating a modulus of only the carrier frequency to isolate the analyte signal.

5. The method according to claim 4, wherein the identifying the presence of the analyte comprises determining whether the modulus exceeds a threshold value.

6. The method according to claim 4, wherein the identifying the presence of the analyte comprises quantitating an amount of analyte present in the sample ion pulses.

7. The method according to claim 1, 3, 4, 5, or 6 wherein the pre-determined time pattern is periodic and the signal conditioning comprises performing a Fourier Transform on the signal to convert it to a frequency-domain signal.

8. The method according to claim 1, 3, 4, 5, 6 or 7, comprising filtering the frequency domain signal of any frequencies outside of a configured bandwidth centered at a frequency corresponding to the periodic pre-determined time pattern.

9. The method according to claims 1 to 8, wherein the signal conditioning comprises a deconvolution of frequency components of the generated signal and wherein the isolating the analyte signal comprises evaluating a pulse frequency component corresponding to the pre-determined time pattern.

10. The method according to claim 9, wherein the identifying the presence of the analyte comprises quantitating an amount of analyte present in the sample ion pulses.

11. The method according to claim 9, wherein a magnitude of the pulse frequency component is used to identify the presence of the analyte.

12. The method according to claim 1, wherein the signal conditioning comprises de-noising.

13. The method according to claim 9, wherein the de-noising comprises selectively rejecting any signal not following the pre-determined time pattern.

14. The method according to claim 1, wherein the signal conditioning comprises:
identifying an initial ion pulse;
windowing the generated signal based on the initial ion pulse and the pre-determined time pattern;
summing the windows to generate a sum of detected ion pulses; and
identifying the presence of the analyte based on the sum of detected ion pulses as compared to a threshold value.

15. The method according to claim 1, wherein the signal conditioning comprises:
identifying an initial ion pulse;
identifying a background signal based on the initial ion pulse and the pre-determined time pattern; and
subtracting the background signal from the generated signal.

16. The method according to any one of claims 1 to 12, comprising quantitating an amount of analyte present in the sample ion pulses.

17. The method according to claim 6, 11, or 16, wherein the quantitating comprises determining a concentration of analyte present in a sample that produced the sample ion pulses.

18. The method according to an one of claims 1 to 17, comprising re-testing a sample that produced the sample ion pulses when the presence of the analyte is identified.

19. A system for mass spectrometry, the system comprising:
a sampling interface that is operable to introduce a plurality of sample pulses to an ionization source;
the ionization source being operable to ionize the pulses and transfer sample ion pulses to a mass spectrometer, the mass spectrometer being operable to:
receive the plurality of sample ion pulses at a pre-determined time pattern;
detect the received sample ion pulses to generate a signal;
isolate an analyte signal by signal conditioning the generated signal based on the pre-determined time pattern; and
identify a presence of an analyte based on the isolated analyte signal.

20. The system according to claim 16, wherein the sampling interface comprises an acoustic drop ejector-open port interface (ADE-OPI).

21. The system according to claim 19, wherein the sampling interface comprises electrospray ionization (ESI), atmospheric pressure chemical ionization (APCI), atmospheric pressure photoionization (APPI), or a matrix-assisted laser desorption/ionization (MALDI) interface.

22. The system according to claim 19, wherein the signal conditioning comprises pulse-based averaging based on the pre-determined time pattern.

23. The system according to claim 19, herein the predetermined time pattern results in sample ion pulses occurring at a specific carrier frequency.

24. The system according to claim 19, wherein the signal conditioning comprises converting the generated signal to a frequency-domain signal and calculating a modulus of only the carrier frequency to isolate the analyte signal.

25. The system according to claim 24, wherein the identifying the presence of the analyte comprises determining whether the modulus exceeds a threshold value.

26. The system according to claim 24, wherein the identifying the presence of the analyte comprises quantitating an amount of analyte present in the sample ion pulses.

27. The system according to claim 19, 23, 24, 25, or 26, wherein the pre-determined time pattern is periodic and the signal conditioning comprises performing a Fourier Transform on the signal to convert it to a frequency-domain signal.

28. The system according to claim 19, 23, 24, 25, 26, or 27, wherein the mass spectrometer is operable to filter the frequency domain signal of any frequencies outside of a configured bandwidth centered at a frequency corresponding to the periodic pre-determined time pattern.

29. The system according to any of claim 19-28, wherein the signal conditioning comprises a deconvolution of frequency components of the generated signal and wherein the isolating the analyte signal comprises evaluating a pulse frequency component corresponding to the pre-determined time pattern.

30. The system according to claim 29, wherein a magnitude of the pulse frequency component is used to identify the presence of the analyte.

31. The system according to claim 30, wherein the identifying the presence of the analyte comprises quantitating an amount of analyte present in the sample ion pulses.

32. The system according to claim 19, wherein the signal conditioning comprises de-noising.

33. The system according to claim 32, wherein the de-noising comprises selectively rejecting any signal not following the pre-determined time pattern.

34. The system according to claim 19, wherein the signal conditioning comprises:
identifying an initial ion pulse;
windowing the generated signal based on the initial ion pulse and the pre-determined time pattern;
summing the windows to generate a sum of detected ion pulses; and
identifying the presence of the analyte based on the sum of detected ion pulses as compared to a threshold value.

35. The system according to claim 19, wherein the signal conditioning comprises:
identifying an initial ion pulse;
identifying a background signal based on the initial ion pulse and the pre-determined time pattern; and
subtracting the background signal from the generated signal.

36. The system according to any one of claims 19-35, comprising quantitating an amount of analyte present in the sample ion pulses.

37. The system according to claim 36, wherein the quantitating comprises determining a concentration of analyte present in a sample that produced the sample ion pulses.

38. The system according to an one of claims 19-37, comprising re-testing a sample that produced the sample ion pulses when the presence of the analyte is identified.

39. The system according to any one of claims 19-38, wherein the sampling interface comprises an acoustic droplet ejector and wherein each sample volume comprises one or more sample droplets.

40. The system according to claim 39, wherein the sample volume comprises 1-50 nL.

41. The system according to any one of claims 39 and 40, wherein the plurality of sample pulses are delivered at a rate of at least one sample pulse per five seconds.

42. The system according to any of claims 19-41, wherein the plurality of sample ion pulses are transferred to the mass spectrometer in less than about 100 seconds.

43. The system according to claim 42, wherein the plurality of sample ion pulses are transferred to the mass spectrometer in less than 15 seconds.

44. The system according to claim 43, wherein the plurality of sample ion pulses comprises five to ten sample volumes transferred to the mass spectrometer in a range of about 0.5 seconds to 15 seconds.
